(19) United States
(12) Patent Application Publication
(10) Pub. No.: US 2026/0348607 A1
(43) Pub. Date: Nov. 5, 2026

(54) HEAT EXCHANGER, AIR CONDITIONER AND REFRIGERATOR INCLUDING SAME

(71) Applicant: SAMSUNG ELECTRONICS CO., LTD., Suwon-si (KR)

(72) Inventors: Woong HWANG, Suwon-si (KR); Minkyung LEE, Suwon-si (KR); Jeongnam CHEON, Suwon-si (KR)

(73) Assignee: SAMSUNG ELECTRONICS CO., LTD., Suwon-si (KR)

(21) Appl. No.: 19/710,034

(22) Filed: Jun. 16, 2026

Related U.S. Application Data
(63) Continuation of application No. PCT/KR2024/019456, filed on Dec. 2, 2024.

(30) Foreign Application Priority Data
Jan. 29, 2024 (KR) 10-2024-0013559

(51) Int. Cl. F24F 11/42; F24F 1/14; H05B 3/20

(52) U.S. Cl. CPC F24F 11/42; F24F 1/14; H05B 3/20

(57) ABSTRACT

A heat exchanger including a tube through which a refrigerant is to flow; a heat exchange fin coupleable to a surface of the tube; a graphene sheet to be in contact with at least a portion of the heat exchange fin so that heat is conducted to the heat exchange fin, the graphene sheet including a graphene layer; and an electrode that is electrically connectable to the graphene layer such that while the electrode is connected to the graphene layer, current is applied to the graphene layer that is configured to receive the current and generate heat.

### CROSS-REFERENCE TO RELATED APPLICATION

This application is a continuation application, under 35 U.S.C. § 111(a), of international application No. PCT/KR2024/019456, filed Dec. 2, 2024, which claims priority under 35 U.S. C. § 119 to Korean Patent Application No. 10-2024-0013559, filed Jan. 29, 2024, the disclosures of which are incorporated herein by reference in their entireties.

### TECHNICAL FIELD

The present disclosure relates to a heat exchanger including graphene, and an air conditioner and a refrigerator including the same.

### BACKGROUND ART

A heat exchanger is a device that exchanges heat between a refrigerant and outside air by including a tube through which the refrigerant flows to exchange heat with the outside air, a heat exchange fin that is in contact with the tube to increase a heat dissipation area, and a header that connects both ends of the tube.

The heat exchanger includes an evaporator or a condenser and configures a refrigeration cycle device together with a compressor that compresses the refrigerant and an expansion valve that expands the refrigerant.

An air conditioner discharges warm or cool air through heat exchange between the refrigerant and outside air in an indoor heat exchanger. An outdoor heat exchanger discharges cool or warm air through heat exchange between the refrigerant and outside air.

A refrigerator includes a heat exchanger for supplying cold air to the storage rooms, that is, an evaporator. The evaporator cools air through heat exchange and the cooled air is supplied to the storage rooms.

### DISCLOSURE

### Technical Problem

An aspect of the present disclosure provides a heat exchanger with improved energy efficiency without an increase in size, and an air conditioner and a refrigerator including the same.

An aspect of the present disclosure provides a heat exchanger with improved heat-exchange efficiency, and an air conditioner and a refrigerator including the same.

An aspect of the present disclosure provides a heat exchanger with improved defrost efficiency, and an air conditioner and a refrigerator including the same.

The technical object intended to be achieved by the present document is not limited to the above-mentioned technical objects, and other technical objects not mentioned will be clearly understood by one of ordinary skill in the technical art to which the present disclosure belongs from the following description.

### Technical Solution

A heat exchanger according to an embodiment may include a tube through which a refrigerant is to flow, a heat exchange fin coupleable to a surface of the tube, a graphene sheet to be in contact with at least a portion of the heat exchange fin to conduct heat to the heat exchange fin, the graphene sheet including a graphene layer, and an electrode electrically connectable to the graphene layer such that while the electrode is connected to the graphene layer, current is applied to the graphene layer that is configured to receive the current and generate heat.

An air conditioner according to an embodiment may include an outdoor unit where a compressor for compressing a refrigerant and an outdoor heat exchanger for causing heat exchange between the refrigerant and air are provided, and an indoor unit where an expansion valve for expanding the refrigerant discharged from the outdoor heat exchanger and an indoor heat exchanger for causing heat exchange between the refrigerant and air are provided, and at least one of the outdoor heat exchanger or the indoor heat exchanger may include a tube through which the refrigerant is to flow, a heat exchange fin coupleable to a surface of the tube, a graphene sheet being in contact with at least a portion of the heat exchange fin to conduct heat to the heat exchange fin, and an electrode electrically connectable to the graphene layer such that while the electrode is connected to the graphene layer, current is applied to the graphene sheet.

A refrigerator according to an embodiment may include a storage room, and a heat exchanger configured to generate cold air to supply the cold air to the storage room, and the heat exchanger may include a tube through which the refrigerant is to flow, a heat exchange fin coupleable to a surface of the tube, a graphene sheet configured to conduct heat to the heat exchange fin to remove frost formed on the tube and the heat exchange fin, the graphene sheet being in contact with at least a portion of the heat exchange fin, and an electrode electrically connectable to the graphene layer such that while the electrode is connected to the graphene layer, current is applied to the graphene layer.

### DESCRIPTION OF DRAWINGS

FIG. 1 is a perspective view schematically showing a heat exchanger according to an embodiment of the present disclosure.

FIG. 2 shows a heat exchange fin of a heat exchanger according to an embodiment of the present disclosure, to which a graphene sheet has been attached.

FIG. 3 shows a heat exchange fin of a heat exchanger according to an embodiment of the present disclosure, to which a graphene sheet has been attached.

FIG. 4 shows a heat exchange fin of a heat exchanger according to an embodiment of the present disclosure, to which a graphene sheet has been attached.

FIG. 5 shows a graphene sheet and electrodes connected to the graphene sheet according to an embodiment of the present disclosure.

FIG. 6 is a cross-sectional view showing a cross section of a heat exchange fin to which a graphene sheet according to an embodiment of the present disclosure has been attached.

FIG. 7 is a cross-sectional view showing a cross section of a heat exchange fin to which a graphene sheet according to an embodiment of the present disclosure has been attached.

FIG. 8 is a cross-sectional view showing a cross section of a heat exchange fin to which a graphene sheet according to an embodiment of the present disclosure has been attached.

FIG. 9 shows a graphene sheet according to an embodiment of the present disclosure and an electrode connected to the graphene sheet.

FIG. 10 shows a cross section of a heat exchange fin to which a graphene sheet according to an embodiment of the present disclosure has been attached.

FIG. 11 shows a cross section of a heat exchange fin to which a graphene sheet according to an embodiment of the present disclosure has been attached.

FIG. 12 shows a cross section of a heat exchange fin to which a graphene sheet according to an embodiment of the present disclosure has been attached.

FIG. 13 is a schematic diagram schematically showing a circulation structure of an indoor unit and an outdoor unit included in an air conditioner according to an embodiment of the present disclosure.

FIG. 14 is a control block diagram of an air conditioner according to an embodiment of the present disclosure.

FIG. 15 is a cross-sectional view schematically showing a refrigerator according to an embodiment of the present disclosure.

FIG. 16 is a control block diagram of an air conditioner according to an embodiment of the present disclosure.

FIG. 17 is a schematical diagram schematically showing a circulation structure of a cold air supply device included in the refrigerator of FIG. 15 according to an embodiment of the present disclosure.

### MODES OF THE INVENTION

Configurations illustrated in the embodiments and the drawings described in the present specification are only the preferred embodiments of the present disclosure, and thus it is to be understood that various modified examples, which may replace the embodiments and the drawings described in the present specification, are possible when filing the present application.

Also, like reference numerals or symbols denoted in the drawings of the present specification represent members or components that perform the substantially same functions.

Also, the terms used in the present specification are merely used to describe embodiments, and are not intended to limit and/or restrict the disclosure. An expression used in the singular encompasses the expression of the plural, unless it has a clearly different meaning in the context. In the present specification, it is to be understood that the terms such as “including” or “having,” etc., are intended to indicate the existence of the features, numbers, operations, components, parts, or combinations thereof disclosed in the specification, and are not intended to preclude the possibility that one or more other features, numbers, operations, components, parts, or combinations thereof may exist or may be added.

Also, it will be understood that, although the terms including ordinal numbers, such as “first”, “second”, etc., may be used herein to describe various components, these components should not be limited by these terms. These terms are only used to distinguish one component from another. For example, a first component could be termed a second component, and, similarly, a second component could be termed a first component, without departing from the scope of the present disclosure. As used herein, the term “and/or” includes any and all combinations of one or more of associated listed items.

Meanwhile, in the following description, the terms “up-down direction”, “lower side”, “front-rear direction”, etc. are defined based on the drawings, and the shapes and positions of the components are not limited by the terms.

Hereinafter, an embodiment of the present disclosure will be described in detail with reference to the accompanying drawings.

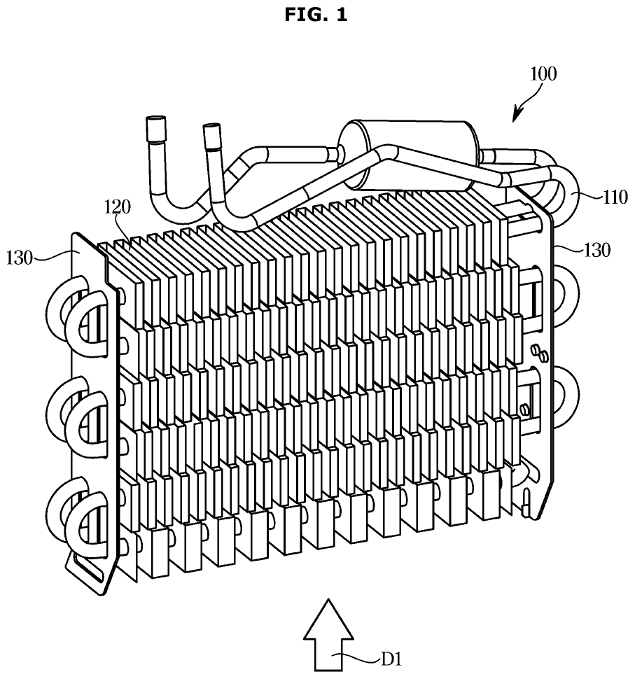

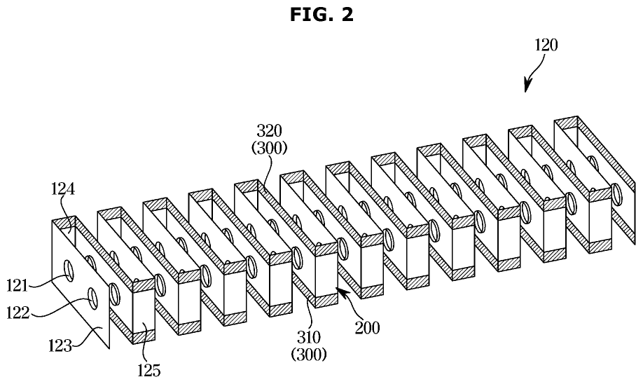

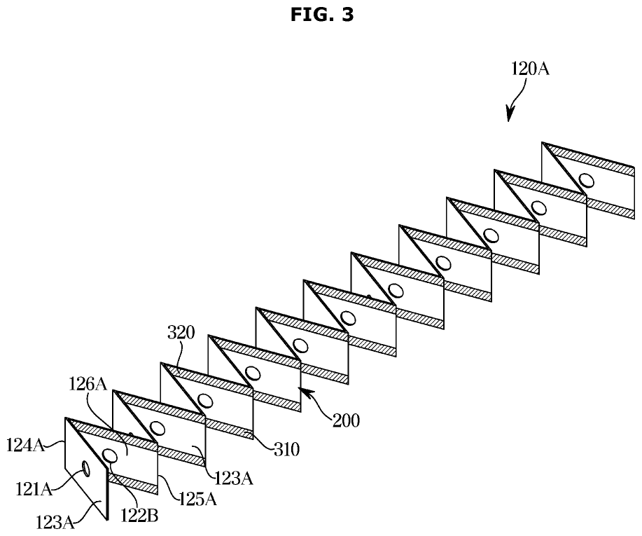

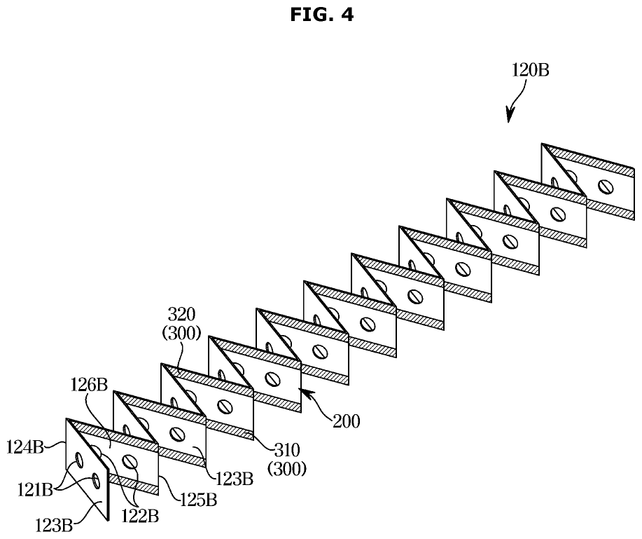

FIG. 1 is a perspective view schematically showing a heat exchanger according to an embodiment of the present disclosure. FIG. 2 shows a heat exchange fin of a heat exchanger according to an embodiment of the present disclosure, to which a graphene sheet has been attached. FIG. 3 shows a heat exchange fin of a heat exchanger according to an embodiment of the present disclosure, to which a graphene sheet has been attached. FIG. 4 shows a heat exchange fin of a heat exchanger according to an embodiment of the present disclosure, to which a graphene sheet has been attached.

Referring to FIGS. 1 to 4, a heat exchanger 100 may include a tube 110 through which a refrigerant flows. In the heat exchanger 100, heat exchange between the refrigerant flowing through the tube 110 and surrounding air may occur. In the present drawings, air may move along an up-down direction of the heat exchanger 100.

The tube 110 may extend along one direction relative ends 130 of the heat exchanger 100. The tube 110 may extend along a direction that is perpendicular to a movement direction D1 of air. That is, the tube 110 may extend perpendicularly to the up-down direction which is the movement direction D1 of air. In the present drawings, the tube 110 may extend along a left-right direction.

The tube 110 may be bent to be arranged along the movement direction D1 of air. That is, portions of the tube 110 extending in the left-right direction may be arranged in the up-down direction.

The heat exchanger 100 may include a heat exchange fin 120. The heat exchange fin 120 may be coupled to a surface of the tube 110. A plurality of heat exchange fins 120 may be provided. More specifically, the plurality of heat exchange fins 120 may be arranged along the movement direction D1 of air. That is, the heat exchange fins 120 may be respectively coupled to the portions of the tube 110, arranged along the up-down direction. In other words, each heat exchange fin 120 may be formed to correspond to one of layers through which the tube 110 passes, although not limited thereto. However, a plurality of heat exchange fins 120 may be arranged in such a way as to be spaced apart from each other along an extension direction of the tube 110.

For convenience of description, the movement direction D1 of air is described as being the up-down direction. However, the present disclosure is not limited thereto. The heat exchanger 100 may be provided in any form to facilitate heat exchange between air and a refrigerant in the tube 110.

The heat exchange fin 120 may include a metal material with high thermal conductivity. For example, the heat exchange fin 120 may include aluminum. However, the heat exchange fin 120 is not limited thereto and may include various materials with high thermal conductivity.

The heat exchange fin 120 may be arranged without interfering with a movement of air. The heat exchange fin 120 may be repeatedly bent along one direction. That is, the heat exchange fin 120 may be repeatedly bent to form preset spacings along the extension direction of the tube 110.

The heat exchange fin 120 may include a vertical portion 123 that is perpendicular to the extension direction of the tube 110. Tube holes 121 and 122 through which the tube 110 passes may be formed in the vertical portion 123. A plurality of vertical portions 123 may be arranged with preset spacings along the extension direction of the tube 110. That is, air may move between the vertical portions 123.

The heat exchange fin 120 may include a first bent portion 124 bent from the vertical portion 123. The first bent portion 124 may be bent at approximately a right angle from the vertical portion 123. A distance between the vertical portions 123 may correspond to a width of the first bent portion 124.

The heat exchange fin 120 may include a second bent portion 125 bent from the vertical portion 123. The second bent portion 125 may be opposite to the first bent portion 124. That is, the first bent portion 124 and the second bent portion 125 may be alternately arranged at opposite sides.

A width of the second bent portion 125 may correspond to that of the first bent portion 124. The vertical portions 123 may be arranged with a constant distance. Air may exchange heat with a refrigerant in the tube 110 while passing between the vertical portions 123.

The heat exchanger 100 may include a graphene sheet 200 that covers at least a portion of the heat exchange fin 120. The graphene sheet 200 may be attached onto at least a portion of the heat exchange fin 120. The graphene sheet 200 may cover one side of the heat exchanger 100, although not limited thereto. However, the graphene sheet 200 may cover both sides of the heat exchanger 100. Also, the graphene sheet 200 may cover a part of the heat exchanger 100.

The graphene sheet 200 may be repeatedly bent along the heat exchange fin 120. By attaching the graphene sheet 200 onto the heat exchange fin 120 and then bending the heat exchange fin 120, the graphene sheet 200 may be bent together with the heat exchange fin 120. Alternatively, after the heat exchange fin 120 is bent, the graphene sheet 200 may be bent and attached onto the heat exchange fin 120.

The heat exchanger 100 may include an electrode 300 that applies current to the graphene sheet 200. The electrode 300 may include a pair of electrodes 310 and 320. The pair of electrodes 310 and 320 may have different potentials. That is, a potential difference may be formed by the pair of electrodes 310 and 320.

The pair of electrodes 310 and 320 may extend along the extension direction of the heat exchange fin 120. More specifically, the pair of electrodes 310 and 320 may extend along the vertical portion 123, the first bent portion 124, and the second bent portion 125. In this case, the pair of electrodes 310 and 320 may be spaced apart from each other. The pair of electrodes 310 and 320 may be spaced apart from each other along a width direction of the heat exchange fin 120.

Referring to FIG. 3, a heat exchange fin 120A according to an embodiment of the present disclosure may be repeatedly folded along the extension direction of the tube 110.

The heat exchange fin 120A may include a first inclined portion 123A. The first inclined portion 123A may be inclined at a preset angle with respect to the tube 110.

The heat exchange fin 120A may include a second inclined portion 126A folded from the first inclined portion 123A. The second inclined portion 126A and the first inclined portion 123A may be symmetric with respect to a direction that is different from the movement direction D1 (see FIG. 1) of air among directions that are perpendicular to the extension direction of the tube 110.

The heat exchange fin 120A may include a first folding portion 124A folded from the first inclined portion 123A. The first folding portion 124A may be an edge formed between the first inclined portion 123A and the second inclined portion 126A.

The heat exchange fin 120A may include a second folding portion 125A folded from the second inclined portion 124A. The second folding portion 125A may be an edge formed between the second inclined portion 126A and the first inclined portion 123A.

The heat exchange fin 120A may include a first through hole 121A which is formed in the first inclined portion 123A and through which the tube 110 passes. The heat exchange fin 120A may include a second through hole 122B which is formed in the second inclined portion 126A and through which the tube 110 passes. One first through hole 121A and one second through hole 122B may be provided.

Referring to FIG. 4, a heat exchange fin 120B according to an embodiment of the present disclosure may be repeatedly folded along the extension direction of the tube 110.

The heat exchange fin 120B may include a first inclined portion 121B. The first inclined portion 123B may be formed at a preset angle with respect to the tube 110.

The heat exchange fin 120B may include a second inclined portion 126B folded from the first inclined portion 123B. The second inclined portion 126B and the first inclined portion 123B may be symmetric with respect to a direction that is different from the movement direction D1 (see FIG. 1) of air among directions that are perpendicular to the extension direction of the tube 110.

The heat exchange fin 120B may include a first folding portion 124B folded from the first inclined portion 123B. The first folding portion 124B may be an edge formed between the first inclined portion 123B and the second inclined portion 126B.

The heat exchange fin 120B may include a second folding portion 125B folded from the second inclined portion 124B. The second folding portion 125B may be an edge formed between the second inclined portion 126B and the first inclined portion 123B.

The heat exchange fin 120B may include a first through hole 121B which is formed in the first inclined portion 123B and through which the tube 110 passes. The heat exchange fin 120B may include a second through hole 122B which is formed in the second inclined portion 126B and through which the tube 110 passes. A pair of first through holes 121B and a pair of second through holes 122B may be provided.

However, the present disclosure is not limited thereto, and the numbers of the first through holes and the second through holes may depend on the number of tubes passing through one heat exchange fin. That is, in a case where three tubes pass through one heat exchange fin, three first through holes and three second through holes may be provided.

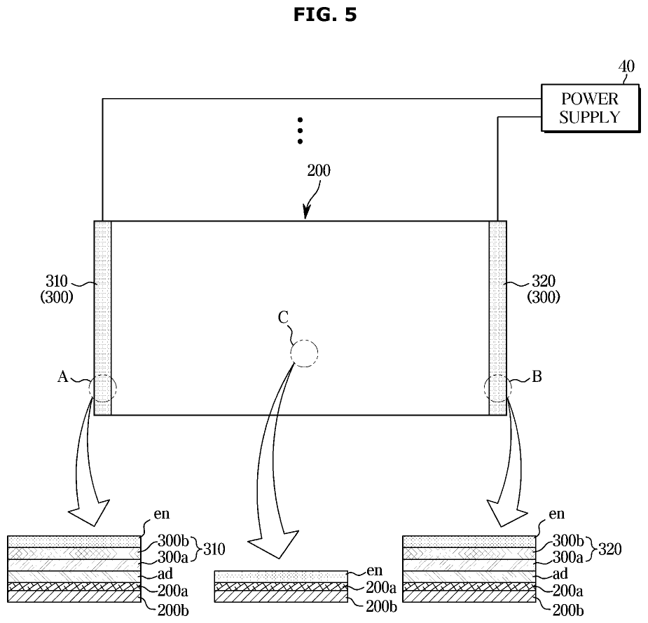

FIG. 5 shows a graphene sheet and electrodes connected to the graphene sheet.

Structures of the graphene sheet 200 and the electrode 300 will be described in detail with reference to FIG. 5.

The graphene sheet 200 may extend along one direction. The graphene sheet 200 may have a length corresponding to the heat exchange fin 120 to be attached onto the heat exchange fin 120 (see FIG. 2).

The electrode 300 may extend along the extension direction of the graphene sheet 200. A plurality of electrodes 300 may be respectively positioned at both sides of the graphene sheet 200. The electrodes 300 may be spaced apart from each other by a length corresponding to a width of the graphene sheet 200.

Each of the plurality of electrodes 300 may be electrically connected to a power supply 40. The plurality of electrodes 300 may be a pair of electrodes. For example, each of the plurality of electrodes 300 may be electrically connected to the power supply 40 by a wire. Each of the plurality of electrodes 300 may be connected to the power supply 40, and the power supply 40 may generate a potential difference between the plurality of electrodes 300 or remove a potential difference between the plurality of electrodes 300. The graphene sheet 200 may receive power from the power supply 40 through the plurality of electrodes 300.

According to a voltage being applied between the plurality of electrodes 300, an electric field may be generated in an area of the graphene sheet 200 between the plurality of electrodes 300. As a result, current may flow in the area of the graphene sheet 200 between the plurality of electrodes 300, and heat may be generated in the area due to resistance. In this way, the graphene sheet 200 may generate heat based on application of a voltage.

A of FIG. 5 is an enlarged cross-sectional view of layers of the graphene sheet 200 and the first electrode 310 among the pair of electrodes 310 and 320, which are in contact with each other. B of FIG. 5 is an enlarged cross-sectional view of layers of the graphene sheet 200 and the second electrode 320 among the pair of electrodes 310 and 320, which are in contact with each other. C of FIG. 5 is an enlarged cross-sectional view of layers of the graphene sheet 200 located between the pair of electrodes 310 and 320.

Structures of A and B of FIG. 5 may correspond to each other.

Referring to A, B, and C of FIG. 5, the graphene sheet 200 may include a graphene layer 200a in which graphene is arranged as at least one layer, and a base layer 200b supporting the graphene layer 200a. That is, the graphene sheet 200 may include the graphene layer 200a and the base layer 200b.

When a voltage is applied to the graphene layer 200a and current flows through the graphene layer 200a, the graphene layer 200a may generate heat due to resistance. A thickness of one graphene layer may be about 0.2 nanometers, and for example, a thickness of the graphene layer 200a provided in the graphene sheet 200s may be 10 micrometers or less. As such, because the graphene layer 200a itself has a very thin thickness, the graphene sheet 200 may require the base layer 200b for supporting the graphene layer 200a. For example, the base layer 200b may have a thickness of about 50 micrometers. The base layer 200b may be formed in a shape of a thin film onto which the graphene layer 200b is attached and which supports the graphene layer 200b.

The graphene layer 200a may be bonded to one surface of the base layer 200b. For example, the graphene layer 200a may be bonded to the base layer 200b by intermolecular forces (van der Waals force, etc.).

Because the graphene layer 200a is a part that generates heat according to application of a voltage, the base layer 200b may be made of a material with high heat resistance. For example, the base layer 200b may be made of a material including polyamide, although not limited thereto. However, the base layer 200b may be made of various materials such as a resin material including polyethylene terephthalate (PET).

Due to high flexibility of graphene, the graphene layer 200a may have high flexibility. Also, the base layer 200b may have high flexibility. For example, the base layer 200b may be formed as a film made of a material including the aforementioned polyamide, polyethylene terephthalate, etc. Therefore, the graphene layer 200a and the base layer 200b may be easily bent.

Referring to A and B of FIG. 5, each of the plurality of electrodes 300 may be bonded to the graphene sheet 200. More specifically, each of the plurality of electrodes 300 may be attached onto the graphene layer 200a. Each of the plurality of electrodes 300 may be attached onto one surface of the graphene layer 200a, which is opposite to another surface bonded to the base layer 200b, among both surfaces of the graphene layer 200a. Therefore, each of the plurality of electrodes 300 may be electrically connected to the graphene layer 200a, and according to a voltage being applied between the plurality of electrodes 300, current may flow through the graphene layer 200a.

Referring to A and B of FIG. 5, each of the plurality of electrodes 300 may be bonded to a graphene sheet 200 by an adhesive layer ad. The graphene sheet 200 may be attached onto the graphene layer 200a by the adhesive layer ad. The adhesive layer ad may be positioned between the graphene layer 200a and the electrodes 300. The adhesive layer ad may have high electrical conductivity to electrically connect each of the plurality of electrodes 300 to the graphene layer 200a.

For example, the adhesive layer ad may include various kinds of conductive adhesives such as silver paste.

For example, the adhesive layer ad may have a thickness of about 10 micrometers or less, although not limited thereto.

However, each of the plurality of electrodes 300 may be bonded to the graphene layer 200a by various methods.

For example, referring to A and B of FIG. 5, each of the plurality of electrodes 300 may include a contact electrode 300a. The contact electrode 300a may be in contact with the graphene sheet 200 and electrically connected to the graphene sheet 200. More specifically, the contact electrode 300a may be attached onto one surface of the graphene layer 200a, which is opposite to another surface bonded to the base layer 200b, among the both surfaces of the graphene layer 200a. The contact electrode 300a may be electrically connected to the power supply 40. The graphene layer 200a may receive a voltage through the plurality of contact electrodes 300a.

The contact electrode 300a may include a conductive material. For example, the contact electrode 300a may include various kinds of conductive metal materials such as copper.

For example, the contact electrode 300a may have a thickness of about 60 micrometers.

For example, the adhesive layer ad as described above may be provided between the contact electrode 300a and the graphene layer 200a. The contact electrode 300a may be attached onto the graphene layer 200a by the adhesive layer ad. The contact electrode 300a may be electrically connected to the graphene layer 200a by the adhesive layer ad.

For example, referring to A and B of FIG. 5, each of the plurality of electrodes 300 may include a pad electrode 300b. The pad electrode 300b may be electrically connected to the contact electrode 300a. The pad electrode 300b may be bonded to the contact electrode 300a. The pad electrode 300b may be attached onto one surface of the contact electrode 300a, which is opposite to another surface facing the graphene layer 200a. The pad electrode 300b may be electrically connected to the power supply 40.

The pad electrode 300b may include a conductive material. For example, the pad electrode 300b may be formed by soldering various kinds of conductive metals such as solder.

For example, the contact electrode 300a and the pad electrode 300b may be bonded to each other by a conductive adhesive such as silver paste, although not limited thereto. However, the contact electrode 300a and the pad electrode 300b may be bonded to each other by various methods.

For example, a wire connecting each of the plurality of electrodes 300 to the power supply 40 may be connected to the pad electrode 300b and/or the contact electrode 300a. As a result, the plurality of electrodes 300 may be electrically connected to the power supply 40, and the graphene layer 200a may receive a voltage through the plurality of electrodes 300.

Referring to A, B, and C of FIG. 5, the graphene sheet 200 may further include an encapsulation layer en. That is, the graphene sheet 200 may include the encapsulation layer en. The encapsulation layer en may protect the graphene layer 200a from outside. The encapsulation layer en may be positioned on one surface of the graphene layer 200a, which is opposite to the base layer 200b. The encapsulation layer en may be formed through an encapsulation process of wrapping the one surface of the graphene layer 200a, which is opposite to the base layer 200b. The encapsulation layer en may form an outer surface of the graphene sheet 200.

Referring to A and B of FIG. 5, the encapsulation layer en may cover each of the plurality of electrodes 300. More specifically, the encapsulation layer en may cover the pad electrode 300b of each of the plurality of electrodes 300.

Referring to C of FIG. 5, the encapsulation layer en may cover the graphene layer 200a.

In other words, the encapsulation layer en may cover the entire of one surface of the graphene layer 200a and form one surface of the graphene sheet 200, and the plurality of electrodes 300 may be positioned between a portion of the encapsulation layer en and a portion of the graphene layer 200a.

The encapsulation layer en may include a material having high flexibility. The encapsulation layer en may include a material having high moisture resistance or heat resistance. For example, the encapsulation layer en may include various materials including a resin material, such as epoxy and polyethylene terephthalate (PET).

For example, the encapsulation layer en may be formed in a shape of a flexible and thin film.

For example, the encapsulation layer en may have a thickness of about 50 micrometers.

A structure of layers constituting the graphene sheet 200 and the plurality of electrodes 300 is not limited as described above. Also, the thickness, material, etc. of each of the layers constituting the graphene sheet 200, the plurality of electrodes 300, etc. are not limited as described above.

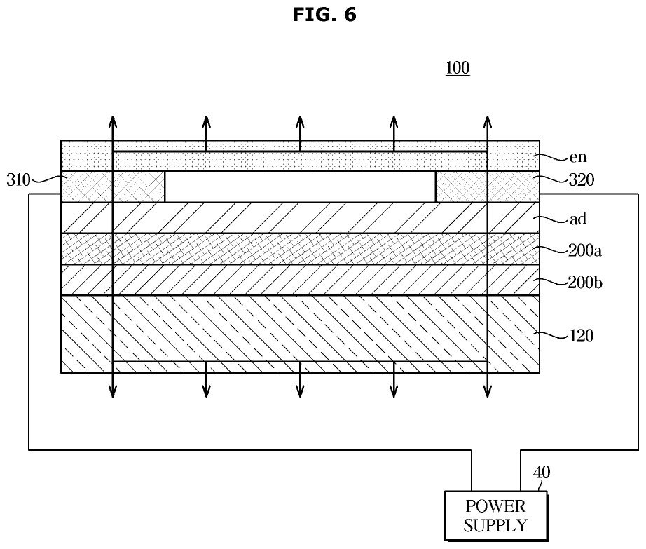

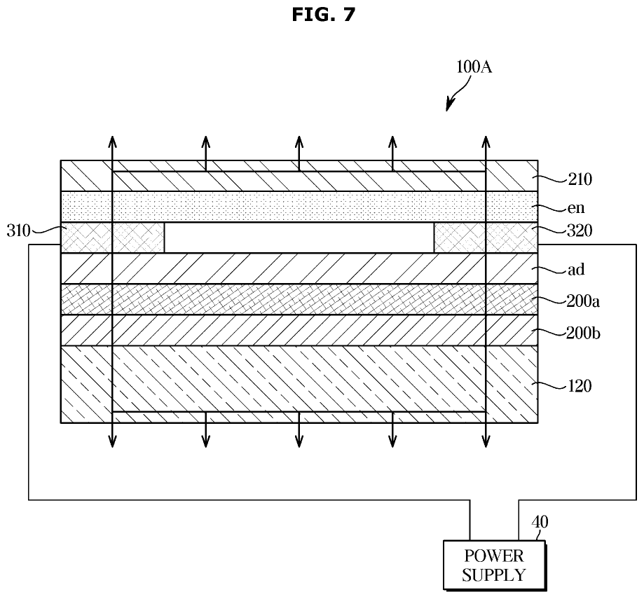

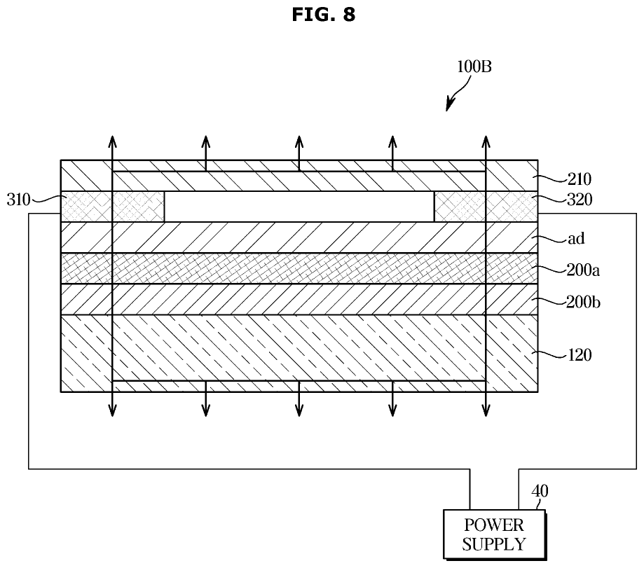

FIG. 6 is a cross-sectional view showing a cross section of a heat exchange fin to which a graphene sheet according to an embodiment of the present disclosure has been attached. FIG. 7 is a cross-sectional view showing a cross section of a heat exchange fin to which a graphene sheet according to an embodiment of the present disclosure has been attached. FIG. 8 is a cross-sectional view showing a cross section of a heat exchange fin to which a graphene sheet according to an embodiment of the present disclosure has been attached.

Referring to FIGS. 6 to 8, the graphene sheet 200 may be attached onto the heat exchange fin 120 according to an embodiment of the present disclosure and current may be supplied to the graphene sheet 200. Due to the current supplied to the graphene sheet 200, heat may be generated in the graphene layer 200a. Based on an enlarged cross section of the heat exchange fin 120 onto which the graphene sheet 200 is attached, a movement of heat generated in the graphene sheet 200 will be described.

Referring to FIG. 6, the heat exchanger 100 according to an embodiment of the present disclosure may include the graphene sheet 200 that covers the heat exchange fin 120. The graphene sheet 200 may receive current from the power supply 40. The graphene layer 200a of the graphene sheet 200 may generate heat by the supplied current. The generated heat may be discharged through the heat exchange fin 120 and the encapsulation layer en.

The base layer 200b may be positioned between the graphene layer 200a and the heat exchange fin 120. However, because the base layer 200b is sufficiently thin, heat generated in the graphene layer 200a may be conducted to the heat exchange fin 120. Likewise, because the adhesive layer ad is also sufficiently thin, heat generated in the graphene layer 200a may be conducted to the encapsulation layer en through the pair of electrodes 310 and 320.

Also, because the pair of electrodes 310 and 320 are also sufficiently thin, the generated heat may be conducted to the encapsulation layer en. A gap between the graphene layer 200a and the encapsulation layer en may be filled with air. However, because a distance between the pair of electrodes 310 and 320 is sufficiently large compared to the thickness of the pair of electrodes 310 and 320, the encapsulation layer en may be in contact with the graphene layer 200a. That is, heat generated in the graphene layer 200a may be conducted directly to the encapsulation layer en.

Air around the heat exchange fin 120 may be heated by heat generated in the graphene sheet 200 although the air does not exchange heat with a refrigerant flowing in the heat exchange fin 120. That is, in a case where the heat exchanger 100 is a condenser that heats surrounding air, the heat exchanger 100 may efficiently heat the surrounding air. In the case where the heat exchanger 100 is a condenser, energy efficiency may increase.

Hereinafter, another embodiment that is different from the heat exchanger 100 of FIG. 6 will be described. Like components are assigned like reference numerals, and detailed descriptions thereof are omitted. Different components will be described in detail.

Referring to FIG. 7, a heat exchanger 100A according to an embodiment of the present disclosure may include a graphene coating 210 that is in contact with the graphene sheet 200.

The graphene coating 210 may be in contact with the graphene sheet 200 such that heat generated in the graphene sheet 200 is conducted to the graphene coating 210. More specifically, heat generated in the graphene sheet 200 may be conducted to the graphene coating 210 by current supplied from the pair of electrodes 310 and 320.

The graphene coating 210 may cover the graphene sheet 200. The graphene coating 210 may be provided on an outermost side. The graphene coating 210 may be provided by spraying a material containing graphene. Alternatively, the graphene coating 210 may be provided by immersing in a solution containing graphene. In addition, the graphene coating 210 may be provided by various methods.

The graphene coating 210 may have excellent thermal conductivity by containing graphene. When heat generated in the graphene sheet 200 is conducted to the graphene coating 210, the heat may be rapidly conducted over an area where the graphene coating 210 is applied.

Heat generated in the graphene layer 200a may be transmitted through the pair of electrodes 310 and 320 and the encapsulation layer en and conducted to the graphene coating 210. Also, heat generated in the graphene layer 200a may be conducted to the heat exchange fin 120 through the base layer 200b.

Referring to FIG. 8, in a heat exchanger 100B according to an embodiment of the present disclosure, the graphene coating 210 may protect the graphene sheet 200. That is, the graphene coating 210 may replace the encapsulation layer en. The graphene coating 210 may form an outer surface of the heat exchange fin 120.

The graphene coating 210 may be applied onto an outermost side of the heat exchange fin 120. The graphene coating 210 may cover the entire of the graphene sheet 200. That is, when heat generated in the graphene sheet 200 is conducted to the graphene coating 210, the heat may be rapidly conducted over an area where the graphene coating 210 is applied.

Heat generated in the graphene layer 200a may be transmitted through the pair of electrodes 310 and 320 and conducted to the graphene coating 210. Also, heat generated in the graphene layer 200a may be conducted to the heat exchange fin 120 through the base layer 200b.

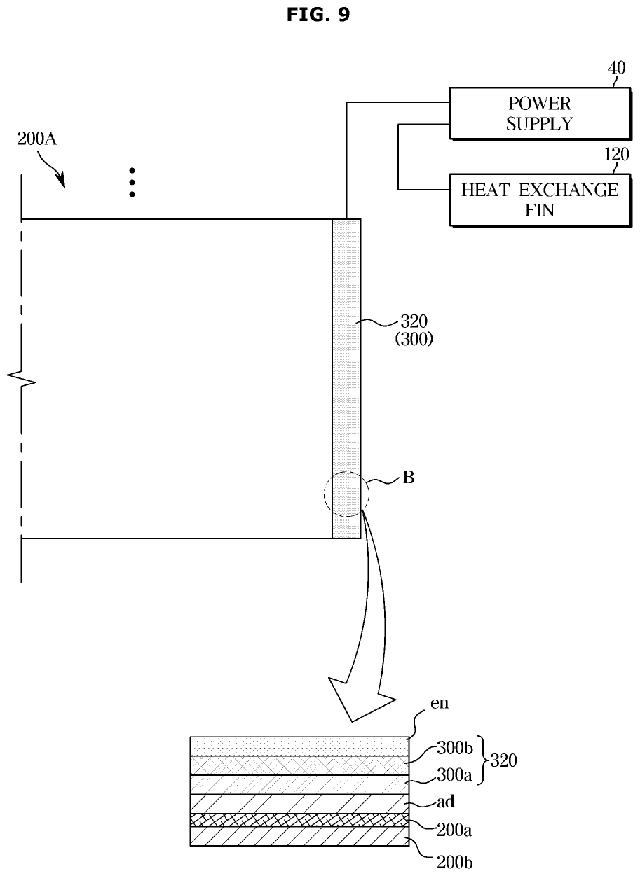

FIG. 9 shows a graphene sheet according to an embodiment of the present disclosure and an electrode connected to the graphene sheet.

Referring to FIG. 9, a single electrode 300 may be connected to a graphene sheet 200A according to an embodiment of the present disclosure. An electrode 320 may extend along one side of the graphene sheet 200A.

The electrode 320 may be electrically connected to the power supply 40. The electrode 320 may be provided as one piece. The electrode 320 may be electrically connected to the power supply 40 by a wire. The heat exchange fin 120 may be connected to the power supply 40. The heat exchange fin 120 may include a conductive metal material. That is, the heat exchange fin 120 may act as an electrode. The power supply 40 may generate a potential difference between the electrode 320 and the heat exchange fin 120 or remove a potential difference between the electrode 320 and the heat exchange fin 120. The graphene sheet 200 may receive power from the power supply 40 through the electrode 320 and the heat exchange fin 120.

For example, according to a voltage being applied to the electrode 320 and the heat exchange fin 120, an electric field may be generated at an area between the electrode 320 and the heat exchange fin 120 in the graphene sheet 200. Accordingly, current may flow at an area between the plurality of electrodes 300 in the graphene sheet 200 and heat may be generated at the area by resistance. As a result, the graphene sheet 200 may generate heat based on application of a voltage.

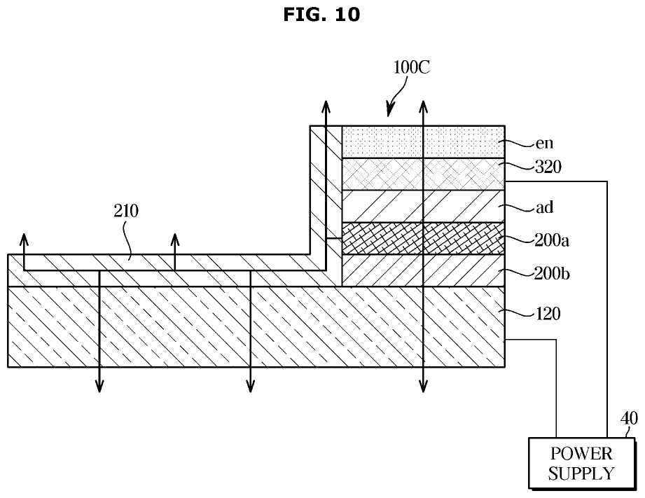

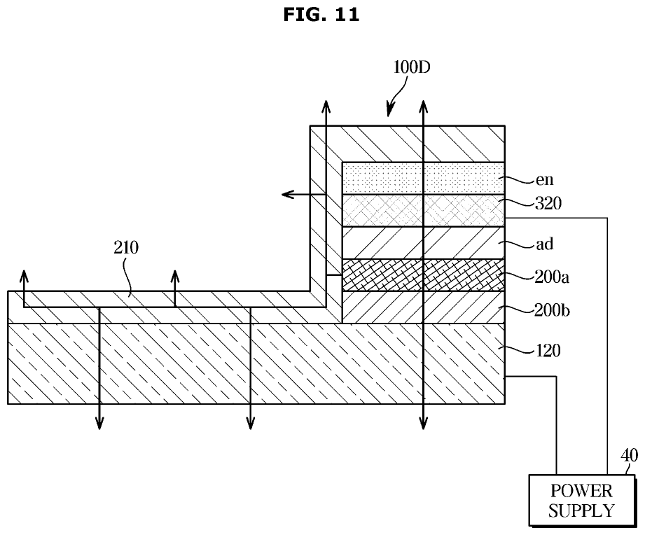

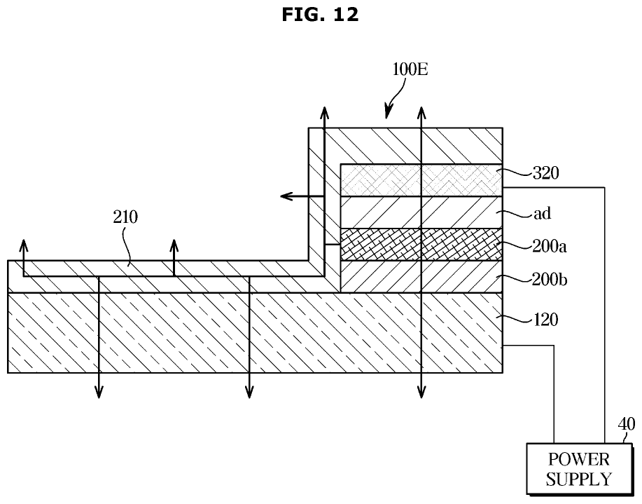

FIG. 10 shows a cross section of a heat exchange fin to which a graphene sheet according to an embodiment of the present disclosure has been attached. FIG. 11 shows a cross section of a heat exchange fin to which a graphene sheet according to an embodiment of the present disclosure has been attached. FIG. 12 shows a cross section of a heat exchange fin to which a graphene sheet according to an embodiment of the present disclosure has been attached.

A movement path of heat generated in the graphene layer 200a will be described with reference to FIGS. 10 to 12. Arrows shown in the drawings schematically show movement paths of heat.

Referring to FIG. 10, a heat exchanger 100C according to an embodiment of the present disclosure may include the graphene sheet 200 that covers a portion of the heat exchange fin 120.

The graphene sheet 200 may cover only a portion of the heat exchange fin 120. The remaining portion of the heat exchange fin 120 may not be covered by the graphene sheet 200.

The heat exchanger 100C may include the graphene coating 210 that covers the remaining portion of the heat exchange fin 120, not covered by the graphene sheet 200.

The graphene coating 210 may cover the remaining portion of the heat exchange fin 120. Also, the graphene coating 210 may cover a portion of the graphene sheet 200. The graphene coating 210 may form an outer surface of the heat exchange fin 120 together with the encapsulation layer en. The graphene coating 210 may protect the heat exchange fin 120 and the graphene sheet 200 from the outside, together with the encapsulation layer en.

The graphene coating 210 may conduct heat generated in the graphene layer 200a. The graphene coating 210 may be in direct contact with the graphene layer 200a.

The graphene coating 210 may be in contact with the heat exchange fin 120. Heat generated in the graphene layer 200a may be conducted to the heat exchange fin 120 through the graphene coating 210.

Heat generated in the graphene layer 200a may also be conducted through the electrode 320 and the encapsulation layer en. Also, heat generated in the graphene layer 200a may be conducted to the heat exchange fin 120 through the base layer 200b.

Referring to FIG. 11, a heat exchanger 100D according to an embodiment of the present disclosure may include the graphene coating 210 that covers both the heat exchange fin 120 and the graphene sheet 200.

The heat exchanger 100C may include the graphene coating 210 that covers the remaining portion of the heat exchange fin 120, not covered by the graphene sheet 200.

The graphene coating 210 may cover the remaining portion of the heat exchange fin 120. Also, the graphene coating 210 may cover a portion of the graphene sheet 200. The graphene coating 210 may cover the encapsulation layer en positioned on an outermost side of the graphene sheet 200.

The graphene coating 210 may be in contact with the heat exchange fin 120. Heat generated in the graphene layer 200a may be conducted to the heat exchange fin 120 through the graphene coating 210.

Heat generated in the graphene layer 200a may be transmitted through the electrode 320 and the encapsulation layer en and conducted to the graphene coating 210. Also, heat generated in the graphene layer 200a may be conducted to the heat exchange fin 120 through the base layer 200b.

Referring to FIG. 12, in a heat exchanger 100E according to an embodiment, the graphene coating 210 may protect the graphene sheet 200. That is, the graphene coating 210 may replace the encapsulation layer en. The graphene coating 210 may form an outer surface of the heat exchange fin 120.

The graphene coating 210 may be applied onto the outermost side of the heat exchange fin 120. The graphene coating 210 may cover the entire of the graphene sheet 200. That is, when heat generated in the graphene sheet 200 is conducted to the graphene coating 210, the heat may be rapidly conducted over an area where the graphene coating 210 is applied.

Heat generated in the graphene layer 200a may be transmitted through the electrode 320 and conducted to the graphene coating 210. Also, heat generated in the graphene layer 200a may be conducted to the heat exchange fin 120 through the base layer 200b.

Hereinafter, a home appliance to which the heat exchanger 100 according to an embodiment of the present disclosure is appliable will be described. The heat exchanger 100 may be used in all home appliances including a heat pump. For example, the heat exchanger 100 may be applied to an air conditioner, a refrigerator, etc.

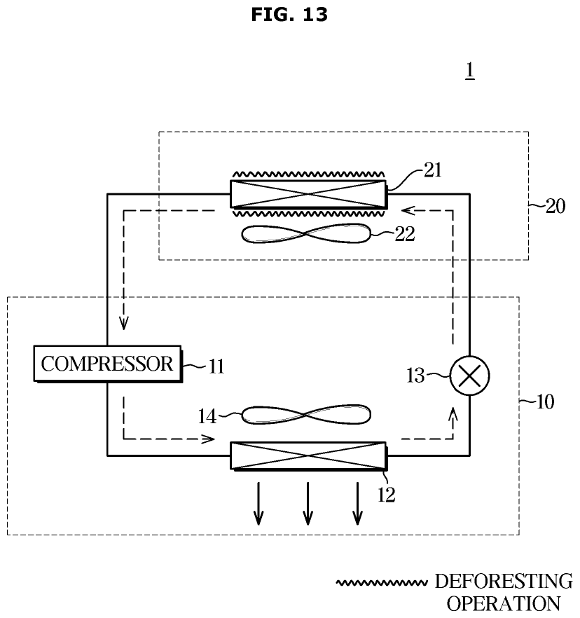

FIG. 13 is a schematic diagram schematically showing a circulation structure of an indoor unit and an outdoor unit included in an air conditioner according to an embodiment of the present disclosure.

Referring to FIG. 13, the heat exchanger 100 according to the present disclosure may be used in an air conditioner 1 including a refrigerant circuit where a compressor 11, an indoor heat exchanger 12, an expansion valve 13, and an outdoor heat exchanger 21 are connected to each other.

Dotted arrows shown indicate a flow of refrigerant during a heating operation of the air conditioner 1, and solid arrows indicate warm air discharged from an indoor unit 10.

The air conditioner 1 may include the indoor unit 10 and an outdoor unit 20 to cool or heat an indoor space.

The indoor unit 10 may include the compressor 11, the indoor heat exchanger 12, the expansion valve 13, and an indoor fan 14, and the outdoor unit 20 may include the outdoor heat exchanger 21 and an outdoor fan 22. A refrigerant pipe through which a refrigerant circulates may be connected between the indoor unit 10 and the outdoor unit 20.

The compressor 11 may compress a refrigerant and discharge a compressed high-temperature gaseous refrigerant to the indoor heat exchanger 12. The indoor heat exchanger 12 may emit heat of the refrigerant to condense the refrigerant. At this time, the high-temperature and high-pressure gaseous refrigerant may be phase-changed to a high-temperature and high-pressure liquid refrigerant.

The expansion valve 13 may lower pressure and temperature of the refrigerant received from the indoor heat exchanger 12 to facilitate heat absorption by evaporation of the refrigerant, and then transfer the refrigerant to the outdoor heat exchanger 21. The high-temperature and high-pressure liquid refrigerant passed through the expansion valve 13 may change to a low-temperature and low-pressure liquid state.

The outdoor heat exchanger 21 may evaporate the refrigerant received from the expansion valve 13 and perform heat exchange with outside air. At this time, the low-temperature and low-pressure liquid refrigerant may be phase-changed to a low-temperature and low-pressure gaseous state.

The heat exchanger 100 according to an embodiment of the present disclosure may be applied to both the indoor heat exchanger 12 and the outdoor heat exchanger 21.

The air conditioner 1 according to an embodiment of the present disclosure may perform a heating operation to heat an indoor space. The indoor heat exchanger 12 of the indoor unit 10 may be used as a condenser. The indoor heat exchanger 12 may emit heat of a received refrigerant to heat indoor air and discharge the air to the indoor space.

The heat exchanger 100 according to an embodiment of the present disclosure may be applied to the indoor heat exchanger 12. The heat exchanger 100 may generate heat by supplying current to the graphene sheet 200 (see FIG. 2). That is, surrounding air may be heated by heat generated in the graphene sheet 200 without operating the compressor 11, thereby improving heat exchange efficiency.

In addition, by operating the compressor 11, heat exchange between the refrigerant of the indoor heat exchanger 12 and surrounding air may occur. At the same time, by supplying current to the graphene sheet 200 to generate heat, the surrounding air may be heated. Heating using a heat pump and heating using the graphene sheet 200 may be performed simultaneously.

In this way, the indoor unit 10 to which the heat exchanger 100 according to an embodiment of the present disclosure is applied may perform a heating operation without operating the compressor 11. That is, because refrigerant circulation by the heat pump is not performed, energy efficiency may be improved. In addition, electrical and thermal conductivity properties of graphene may increase energy efficiency.

While the air conditioner 1 according to an embodiment of the present disclosure performs a heating operation to heat an indoor space, frost may be formed on the outdoor unit 20. Frost may be formed depending on an ambient temperature and humidity of the outdoor heat exchanger 21. During a heating operation of the indoor unit 10, the outdoor heat exchanger 21 of the outdoor unit 20 may discharge cool air, which may cause formation of frost.

The frost formed on the outdoor unit 20 may interrupt normal operations of the air conditioner 1. Accordingly, the outdoor unit 20 may perform a defrosting operation of removing frost formed on the outdoor unit 20.

The outdoor heat exchanger 21 of the outdoor unit 20 may remove frost through the defrosting operation. Frost may be formed on the tube 110 (see FIG. 1) and the heat exchange fin 120 (see FIG. 1) of the outdoor unit 20.

The heat exchanger 100 according to an embodiment of the present disclosure may include the graphene sheet 200 that covers at least a portion of the heat exchange fin 120. By supplying current through the electrode 300 electrically connected to the graphene sheet 200, the graphene sheet 200 may generate heat. The generated heat may be conducted through surrounding components, such as the heat exchange fin 120 or the graphene coating 210 (see FIG. 7).

The heat generated in the graphene sheet 200 may be conducted to the entire of the heat exchange fin 120. Also, the heat generated in the graphene sheet 200 may be rapidly diffused to the entire of the heat exchange fin 120 due to excellent heat conductivity of graphene. Because the heat exchange fin 120 is coupled to the surface of the tube 110, the heat conducted to the heat exchange fin 120 may also be conducted to the tube 110. That is, frost formed on the tube 110 and the heat exchange fin 120 may be removed quickly and easily.

The outdoor unit 20 according to an embodiment of the present disclosure may include a defrost heater (not shown). The defrost heater (not shown) may generate heat around the outdoor heat exchanger 21 to remove formed frost. Because the defrost heater (not shown) does not physically contact the heat exchange fin 120 or the tube 110, the defrost heater may transfer heat through radiation. Heat transfer through radiation may be less efficient than conduction.

The defrost heater (not shown) may generate heat by supplying current to a metal with high electrical resistance and then supply the heat to the heat exchanger 100. Generally, a process of generating heat by supplying current to a metal may consume a lot of energy.

Accordingly, the air conditioner 1 according to an embodiment of the present disclosure may perform defrosting by the graphene sheet 200 without operating the defrost heater (not shown) during a defrosting operation. However, during a defrosting operation, the defrost heater (not shown) and the graphene sheet 200 may operate together to perform defrosting.

The air conditioner 1 according to an embodiment of the present disclosure may easily control a defrosting operation. Because the graphene sheet 200 has excellent electrical conductivity, the graphene sheet 200 may rapidly heat surroundings of the heat exchange fin 120 and the tube 110. That is, defrosting efficiency may be improved.

In addition, because the graphene sheet 200 is lightweight and has a small volume, the graphene sheet 200 may further increase a size of the heat exchanger 100. As the size of the heat exchanger 100 increases, more tubes 110 through which a refrigerant flows and more heat exchange fins 120 may be arranged. As a result, heat exchange efficiency may increase.

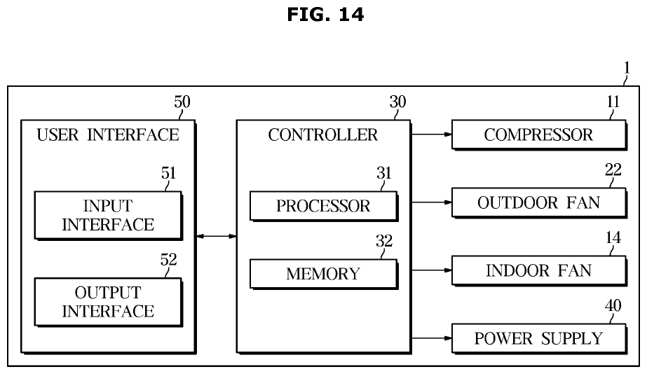

FIG. 14 is a control block diagram of an air conditioner according to an embodiment of the present disclosure.

The air conditioner 1 according to an embodiment of the present disclosure may include a controller 30 that controls various components of the air conditioner 1.

The controller 30 may include a processor 31 that generates a control signal regarding an operation of the air conditioner 1, and memory 32 that stores a program, an application, an instruction, and/or data for an operation of the air conditioner 1. The processor 31 and the memory 32 may be implemented as separate semiconductor devices or a single semiconductor device.

Also, the controller 30 may include a plurality of processors or a plurality of pieces of memory. The controller 30 may be positioned at various locations inside the air conditioner 1.

The processor 31 may include an arithmetic circuit, a memory circuit, and a control circuit. The processor 31 may include a single chip or a plurality of chips. In addition, the processor 31 may include a single core or a plurality of cores.

The memory 32 may store various programs and data required for a control operation and temporarily store temporary data generated during a control operation.

The memory 32 may include volatile memory, such as Static Random Access Memory (SRAM) and Dynamic Random Access Memory (DRAM), and non-volatile memory, such as Read Only Memory (ROM) and Erasable Programmable Read Only Memory (EPROM). The memory 32 may include a single memory device or a plurality of memory devices.

The processor 31 may be electrically connected to the memory 32. The processor 31 may process data and/or a signal by using a program provided from the memory 32 and transmit control signals to the respective components of the air conditioner 1 based on the processed result. The respective components of the air conditioner 1 may operate based on the control signals from the processor 31.

The air conditioner 1 may include a user interface 50. For example, the user interface 50 may receive a touch input. Also, the user interface 50 may output an image.

The user interface 50 may include an input interface 51 for receiving a user's input. The user interface 50 may include a plurality of buttons provided on the air conditioner 1. For example, the input interface 51 may include an operation mode button for setting a cooling mode, a heating mode, a defrost mode, etc., a wind direction button for setting a direction of wind, and/or a wind volume button for setting an intensity of wind (rotation speed of a blower fan).

Each of the plurality of buttons may include a push switch and a membrane switch, which operate when being pressed by a user, and/or a touch switch that operates when being contacted by a user's body part. Also, the input interface 51 may include a remote controller separated from the air conditioner 1, and a receiver that receives a wireless signal from the remote controller.

An output interface 52 may display information about a state and operation of the air conditioner 1. The output interface 52 may display information regarding an operation of the air conditioner 1 as at least one of an image or text. The output interface 52 may be provided on the air conditioner 1. Alternatively, the output interface 52 may be provided on the remote controller and the receiver that receives a wireless signal from the remote controller.

The output interface 52 may be implemented as a Liquid Crystal Display, a Light Emitting Diode, an Organic Light Emitting Diode, and/or a micro LED. Also, the output interface 52 may be implemented as a touch display. The touch display may include a display panel that displays an image, and a touch panel that receives a touch input.

The controller 30 may control an operation of the compressor 11. The controller 30 may operate the compressor 11 to change a refrigerant to a gas in a high-temperature and high-pressure state. The refrigerant compressed by the compressor 11 may circulate through the heat pump. The refrigerant compressed by the compressor 11 may circulate through the indoor heat exchanger 12, the expansion valve 13, and the outdoor heat exchanger 21.

The controller 30 may control the compressor 11 not to operate. The controller 30 may cause the indoor unit 10 to discharge heated air to an indoor space without operating the compressor 11, that is, without operating the heat pump.

The controller 30 may operate the outdoor fan 14. The outdoor fan 14 may supply air to the outdoor heat exchanger 21. That is, the outdoor fan 14 may supply surrounding air to cause heat exchange in the outdoor heat exchanger 21.

The controller 30 may operate the indoor fan 22. The indoor fan 22 may generate an airflow to discharge air heated or cooled in the indoor heat exchanger 12 to the indoor space.

The controller 30 may control the power supply 40. The controller 30 may be electrically connected to the power supply 40. The controller 30 may control the power supply 40 based on a user's input. Alternatively, the controller 30 may control an operation mode of the indoor unit 10 based on a user's input. Alternatively, the controller 30 may control an operation mode of the outdoor unit 20 based on a user's input.

The controller 30 may control the indoor unit 10 to perform a heating operation. The controller 30 may control the indoor heat exchanger 12 of the indoor unit 10 to heat surrounding air. The controller 30 may operate the compressor 11 to circulate the refrigerant in the heat pump. The controller 30 may perform control to cause heat exchange between the refrigerant in the indoor heat exchanger 12, that is, the condenser and surrounding air and thus heat the surrounding air. The controller 30 may operate the indoor fan 14 to discharge the air heated in the indoor heat exchanger 12 to the indoor space.

The controller 30 may control the power supply 40 to supply current to the graphene sheet 200 of the indoor heat exchanger 12. The power supply 40 may supply current to the graphene sheet 200 through the electrode 300 such that heat is generated in the graphene layer 200a.

The controller 30 may control the power supply 40 to supply current to the graphene sheet 200, or may operate the compressor 11 to circulate the refrigerant. The controller 30 may operate the compressor 11 while controlling the power supply 40 to supply current to the graphene sheet 200.

The controller 30 may control the outdoor unit 20 to perform a defrosting operation. The controller 30 may operate the defrost heater (not shown) to perform a defrosting operation. During a defrost operation, the controller 30 may control the power supply 40 to supply current to the graphene sheet 200 through the electrode 300.

The graphene sheet 200 may generate heat by the supplied current. The generated heat may be conducted to the heat exchange fin 120 and/or the graphene coating 210 and diffused to the entire of the outdoor heat exchanger 21.

In this way, the controller 30 may control the power supply 40 to generate heat in the graphene sheet 200. That is, the indoor unit 10 may discharge warm air by using heat generated in the graphene sheet 200, thereby warming the indoor space. The outdoor unit 20 may perform defrosting by using the heat generated in the graphene sheet 200.

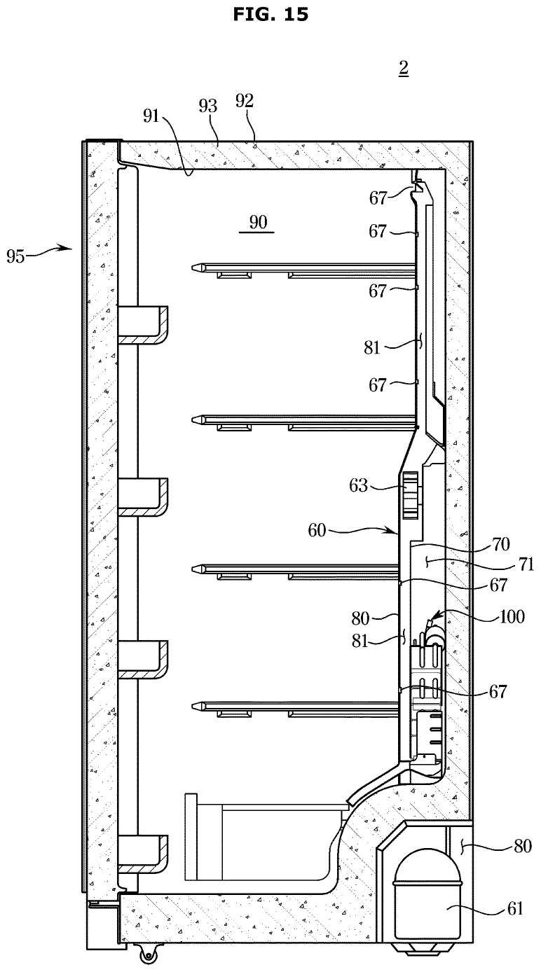

FIG. 15 is a cross-sectional view schematically showing a refrigerator according to an embodiment of the present disclosure.

A refrigerator 2 according to an embodiment of the present disclosure may include an inner case 91 forming a storage room 90, and an outer case 92 forming an appearance. An insulating material 93 may be foamed between the inner case 91 and the outer case 92. The refrigerator 2 may include a door 95 that opens or close an open front side of the storage room 90.

In a rear lower portion of the refrigerator 2, a compressor 61 that compresses a refrigerant and a machine room 80 in which a condenser (not shown) is installed may be provided. The refrigerator 2 may include a cold air supply device 60 that supplies cold air to the storage room 90.

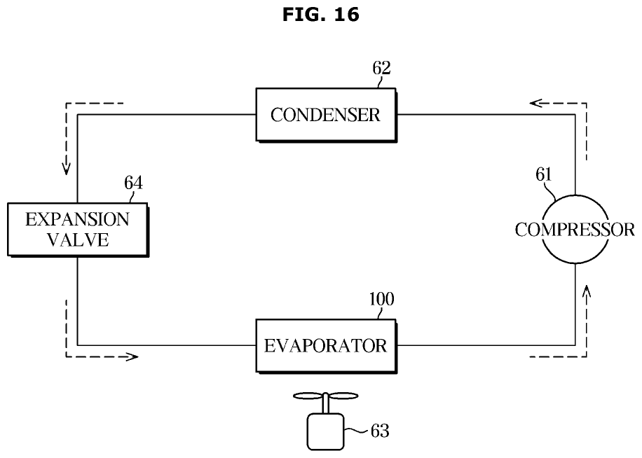

The cold air supply device 60 may include a refrigeration cycle including the evaporator 100, the compressor 61, a condenser 62 (see FIG. 16), and an expansion valve 64 (see FIG. 16), a fan 63 for supplying cold air generated in the evaporator 100 to the storage room 90, and ducts 70 and 80 that form a movement path of air. The heat exchanger 100 included in the cold air supply device 50 which will be described below may be the evaporator 100. That is, the evaporator 100 may be the heat exchanger 100 according to an embodiment of the present disclosure.

The cold air supply device 60 may include the heat exchanger 100 that generates cold air, the ducts 70 and 80 that form a movement path of air inside the cold air supply device 60, and the fan 63 that forms an airflow inside the ducts 70 and 80.

The ducts 70 and 80 may include an intake duct 70 that receives air of the storage room 90 and forms an air intake path 61 passing through the heat exchanger 100, and an exhaust duct 80 that forms an air discharge path 81 for supplying cold air passed through the heat exchanger 100 to the storage room 90. The intake duct 70 may be positioned upstream of the fan 63, and the exhaust duct 80 may be positioned downstream of the fan 63. The exhaust duct 80 may include a plurality of air outlets 67 to disperse cold air to the storage room 90.

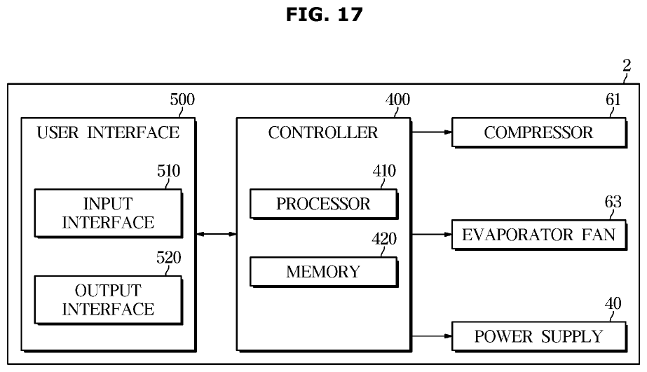

FIG. 16 is a control block diagram of an air conditioner according to an embodiment of the present disclosure. FIG. 17 is a schematical diagram schematically showing a circulation structure of a cold air supply device included in the refrigerator of FIG. 15.

Referring to FIGS. 16 and 17, the refrigerator 2 may include a controller 400 that controls various components of the refrigerator 2.

The controller 400 may include a processor 410 that generates a control signal regarding an operation of the refrigerator 2, and memory 420 that stores a program, an application, an instruction, and/or data for an operation of the refrigerator 2. The processor 410 and the memory 420 may be implemented as separate semiconductor devices or a single semiconductor device.

Also, the controller 400 may include a plurality of processors or a plurality of pieces of memory. The controller 400 may be positioned at various locations inside the refrigerator 2.

The processor 410 may include an arithmetic circuit, a memory circuit, and a control circuit. The processor 410 may include a single chip or a plurality of chips. In addition, the processor 410 may include a single core or a plurality of cores.

The memory 420 may store various programs and data required for a control operation and temporarily store temporary data generated during a control operation.

The memory 420 may include volatile memory, such as Static Random Access Memory (SRAM) and Dynamic Random Access Memory (DRAM), and non-volatile memory, such as Read Only Memory (ROM) and Erasable Programmable Read Only Memory (EPROM). The memory 420 may include a single memory device or a plurality of memory devices.

The processor 410 may be electrically connected to the memory 420. The processor 410 may process data and/or a signal by using a program provided from the memory 420 and transmit control signals to the respective components of the refrigerator 2 based on the processed result. The respective components of the refrigerator 2 may operate based on the control signals from the processor 410.

Electronic parts constituting the controller 400 may be positioned at various locations of the refrigerator 2.

The refrigerator 2 may include a user interface 500. For example, the user interface 500 may receive a touch input. Also, the user interface 500 may output an image.

The user interface 500 may include an input interface 510 for receiving a user's input. The user interface 500 may include a plurality of buttons provided on the refrigerator 2. For example, the input interface 510 may include a temperature control button, etc. for adjusting a refrigerating room temperature, a freezing room temperature, etc.

Each of the plurality of buttons may include a push switch and a membrane switch, which operate when being pressed by a user, and/or a touch switch that operates when being contacted by a user's body part. Also, the input interface 51 may include a remote controller separated from the air conditioner 1, and a receiver that receives a wireless signal from the remote controller.

An output interface 520 may display information about a state and operation of the refrigerator 2. The output interface 520 may display information regarding an operation of the refrigerator 2 as at least one of an image or text. The output interface 520 may be provided on the refrigerator 2. Alternatively, the output interface 520 may be provided on the remote controller and the receiver that receives a wireless signal from the remote controller.

The output interface 520 may be implemented as a Liquid Crystal Display, a Light Emitting Diode, an Organic Light Emitting Diode, and/or a micro LED. Also, the output interface 520 may be implemented as a touch display. The touch display may include a display panel that displays an image, and a touch panel that receives a touch input.

The controller 400 may control an operation of the compressor 61 based on a user's input. The controller 400 may perform control to determine whether to operate the compressor 61 and/or adjust a rotation speed of the compressor 61. The controller 400 may operate the compressor 61 to circulate the refrigerant through the refrigeration cycle.

In the heat exchanger 100, that is, the evaporator 100, heat exchange between the refrigerant and surrounding air may occur. The heat exchanger 100 may cool surrounding air. Cold air generated in the heat exchanger 100 may be supplied to the storage room 90 (see FIG. 15). More specifically, the fan 63 may generate an airflow to supply the cold air generated in the heat exchanger 100 to the storage room 90.

The controller 300(400?) may perform control to operate the evaporator fan 63. The evaporator fan 63 may continue to supply cold air according to circulation of the refrigerant on the cooling cycle. The controller 300(400?) may perform control to stop operating the evaporator fan 63 during defrosting of the heat exchanger 100.

Frost may be formed depending on an ambient temperature and humidity of the heat exchanger 100. Frost formed on the heat exchanger 100 may interrupt normal operations of the heat exchanger 100.

The frost formed around the heat exchanger 100 may need to be removed. That is, the heat exchanger 100 of the refrigerator 2 may need to be defrosted. The refrigerator 2 according to an embodiment of the present disclosure may include the heat exchanger 100 including the graphene sheet 200.

The controller 400 may control the power supply 40. The controller 400 may supply current to the graphene sheet 200 through the electrode 300. The controller 400 may perform control to generate heat in the graphene sheet 200.

The refrigerator 2 may include the defrost heater (not shown) for removing frost formed on the heat exchanger 100. During defrosting, heat generated in the defrost heater (not shown) may be transferred through radiation to melt frost.

The controller 400 may perform control to remove frost formed on the heat exchanger 100 with heat generated in the graphene sheet 200. During defrosting, the controller 400 may control the defrost heater (not shown) and/or the power supply 40.

The controller 400 may perform control to operate only the power supply 40 without operating the defrost heater (not shown). The power supply 40 may supply current to the graphene sheet 200 through the electrode 300. The graphene sheet 200 may generate heat by the supplied current. The generated heat may be conducted through the heat exchange fin 120 and/or the graphene coating 210. Frost formed on the heat exchanger 100 may be removed by the heat conducted through the heat exchange fin 120 and/or the graphene coating 210.

During defrosting, the controller 400 may perform control not to operate the evaporator fan 63. Also, during defrosting, the controller 400 may perform control not to operate the compressor 61.

A heat exchanger 100 according to an embodiment may include a tube 110 through which a refrigerant flows, a heat exchange fin 120 coupled to a surface of the tube, a graphene sheet 200 being in contact with at least a portion of the heat exchange fin to conduct heat to the heat exchange fin, the graphene sheet including a graphene layer 200a configured to receive current and generate heat, and an electrode 300 electrically connected to the graphene layer to apply current to the graphene layer.

The heat exchanger may further include a graphene coating 210 being in contact with the graphene sheet to conduct heat generated in the graphene sheet by current supplied from the electrode.

The graphene coating may be in contact with the heat exchange fin such that heat conducted from the graphene sheet is conducted to the heat exchange fin.

The graphene coating may cover a remaining portion of the heat exchange fin, the remaining portion being not in contact with the graphene sheet.

The graphene coating may cover both the heat exchange fin and the graphene sheet.

The heat exchanger may further include a power supply 40 configured to supply current to the graphene sheet through the electrode.

The electrode may include a pair of electrodes configured to apply current to the graphene sheet.

The pair of electrodes may extend and be bent along the heat exchange fin, and spaced apart from each other along a width direction of the heat exchange fin.

The power supply may be electrically connected to the heat exchange fin, and the heat exchange fin may be electrically connected to the graphene layer to transfer current supplied from the power supply to the graphene layer.

An air conditioner 1 according to an embodiment may include an outdoor unit 20 where a compressor 11 for compressing a refrigerant and an outdoor heat exchanger 21 for causing heat exchange between the refrigerant and air are provided, and an indoor unit 10 where an expansion valve 13 for expanding the refrigerant discharged from the outdoor heat exchanger and an indoor heat exchanger 12 for causing heat exchange between the refrigerant and air are provided, and at least one of the outdoor heat exchanger or the indoor heat exchanger may include a tube 110 through which the refrigerant flows, a heat exchange fin 120 coupled to a surface of the tube, a graphene sheet 200 being in contact with at least a portion of the heat exchange fin to conduct heat to the heat exchange fin, and an electrode 300 electrically connected to the graphene layer to apply current to the graphene layer.

The at least one of the outdoor heat exchanger or the indoor heat exchanger may further include a graphene coating 210 being in contact with the graphene sheet to conduct heat generated in the graphene sheet by current supplied from the electrode.

The graphene coating may cover a remaining portion of the heat exchange fin, the remaining portion being not in contact with the graphene sheet.

The at least one of the outdoor heat exchanger or the indoor heat exchanger may further include a power supply 40 configured to supply current to the graphene sheet through the electrode.

During a defrosting operation, the power supply may supply current to the graphene sheet through the electrode.

The at least one of the outdoor heat exchanger or the indoor heat exchanger may further include a controller 300 configured to operate the compressor or control the power supply to supply current based on a user's input.

During a defrosting operation, the controller may control the power supply to supply current to the graphene sheet through the electrode.

During a heating operation, the controller may control the power supply to supply current to the graphene sheet through the electrode.

During a heating operation, the controller may operate the compressor while controlling the power supply to supply current to the graphene sheet.

A refrigerator 2 according to an embodiment may include a storage room 90, and a heat exchanger 100 configured to generate cold air to supply the cold air to the storage room, and the heat exchanger may include a tube 110 through which the refrigerant flows, a heat exchange fin 120 coupled to a surface of the tube, a graphene sheet 200 configured to conduct heat to the heat exchange fin to remove frost formed on the tube and the heat exchange fin, the graphene sheet being in contact with at least a portion of the heat exchange fin, and an electrode 300 electrically connected to the graphene layer to apply current to the graphene sheet.

The heat exchanger may further include a graphene coating 210 being in contact with the graphene sheet to conduct heat generated in the graphene sheet by current supplied from the electrode, and the graphene coating may cover a remaining portion of the heat exchange fin, the remaining portion being not in contact with the graphene sheet.

According to the present disclosure, energy efficiency may be improved without increasing the size of the heat exchanger.

According to the present disclosure, heat-exchange efficiency may be improved by using graphene having high electrical and thermal conductivity.

According to the present disclosure, defrosting efficiency may be improved by using graphene having high electrical and thermal conductivity.

Effects that can be achieved by the present disclosure are not limited to the above-mentioned those, and other effects not mentioned may be clearly understood by one of ordinary skill in the technical art to which the present disclosure belongs from the following description.

So far, specific embodiments have been shown and described. However, the present disclosure is not limited to the above-described embodiments, and various modifications can be made by those skilled in the technical art to which the present disclosure belongs without departing from the gist of the technical idea of the disclosure defined by the claims below.

1. A heat exchanger comprising:
a tube through which a refrigerant is to flow;
a heat exchange fin coupleable to a surface of the tube;
a graphene sheet to be in contact with at least a portion of the heat exchange fin to conduct heat to the heat exchange fin, the graphene sheet including a graphene layer; and
an electrode electrically connectable to the graphene layer such that while the electrode is connected to the graphene layer, current is applied to the graphene layer that is configured to receive the current and generate heat.

2. The heat exchanger of claim 1, further comprising:
a graphene coating to be in contact with the graphene sheet to conduct heat generated in the graphene sheet by current applied from the electrode.

3. The heat exchanger of claim 2, wherein
the graphene coating is in contact with the heat exchange fin such that the heat conducted from the graphene sheet is conducted to the heat exchange fin.

4. The heat exchanger of claim 3, wherein
the graphene coating covers a remaining portion of the heat exchange fin that is not in contact with the graphene sheet.

5. The heat exchanger of claim 4, wherein
the graphene coating covers both the heat exchange fin and the graphene sheet.

6. The heat exchanger of claim 1, further comprising
a power supply configured to supply current to the graphene sheet through the electrode.

7. The heat exchanger of claim 6, wherein
the electrode is among a pair of electrodes configured to apply current to the graphene sheet.

8. The heat exchanger of claim 7, wherein
the pair of electrodes extend and bend along the heat exchange fin, and are spaced apart from each other along a width direction of the heat exchange fin.

9. The heat exchanger of claim 6, wherein
the power supply is electrically connected to the heat exchange fin, and
the heat exchange fin is electrically connected to the graphene layer to transfer current supplied from the power supply to the graphene layer.
